(19) United States
(12) Patent Application Publication
(10) Pub. No.: US 2024/0392823 A1
(43) Pub. Date: Nov. 28, 2024

(54) Quick Release Pin

(71) Applicant: The Boeing Company, Arlington, VA (US)

(72) Inventors: Kiritharan Gurusamy, Bengaluru (IN); Suman Murugesan, Bengaluru (IN); Jagdish L. Shinde, Bengaluru (IN)

(21) Appl. No.: 18/322,876

(22) Filed: May 24, 2023

(51) Int. Cl. F16B 21/16; F16B 21/08

(52) U.S. Cl. CPC F16B 21/165; F16B 21/08

(57) ABSTRACT

A quick release pin configured to be inserted into openings in one or more members. The quick release pin includes a first end 16 configured to be positioned on a first side of the one or more members, and a second end configured to positioned on an opposing side. The quick release pin is selectively movable between an engaged position and a disengaged position. In the engaged position, ball members are forced radially outward to increase a width to prevent removal. In the disengaged position, the ball members are configured to retract radially inward to allow for removal.

### TECHNOLOGICAL FIELD

The present disclosure relates generally to fasteners and, more specifically, to quick release pins that are movable between engaged and disengaged positions.

### BACKGROUND

A quick release pin is a mechanical device configured to be inserted through one or more openings to lock two parts together. The quick release pin basically includes an elongated body and a locking mechanism that is selectively movable between engaged and disengaged positions. The quick release pin can be used in a wide variety of situations, such as to temporarily lock two parts together such as during maintenance. In one example, quick release pins are used during aircraft maintenance to lock a component in a particular position to provide for a technician to work in a space. Specific uses include the quick release pin locking support legs to hold a cover in an open position to provide access to a hydraulic system of a flight control member.

Existing quick release pins have complex designs that include a large number of individual parts. The complex design makes manufacturing the quick release pins more difficult because the different parts must be assembled. Further, the complex designs and large number of parts can also add to production cost. During use, the complex design can make it more difficult for a technician to use the quick release pin. Further, the large number of parts can provide for a shorter lifespan as failure of a part can result in the quick release pin no longer being effective for its use.

There is a need for a new design for a quick release pin. The new quick release pin should be less complex by including fewer parts. Overall, the new quick release pin should have a more straight-forward and simpler design. This will reduce the overall cost and production and assembly time. Further, the new design should still be able to be effectively used by a technician to lock parts together when in use.

### SUMMARY

One aspect is directed to a quick release pin comprising a housing comprising a hollow interior space and openings that extend through the housing. Ball members are positioned at the openings. A spindle comprising a contact section is aligned with the openings in the housing with the contact section comprising extensions and recesses. A spring is attached to the housing and the spindle. The spindle is rotatable within the housing to selectively force the ball members radially outward through the openings and allow for the ball members to radially retract in the openings.

In another aspect, the ball members comprise a first diameter and the openings comprise a second diameter with the first diameter is larger than the second diameter to prevent the ball members from escaping from the housing through the openings.

In another aspect, the contact section is positioned at a distal end of the spindle.

In another aspect, the spring is a torsion spring that applies a force to the housing upon rotation of the spindle.

In another aspect, the contact section comprises a cross-sectional width that is measured through a center point C of the spindle with the width being greater at the extensions than at the recesses.

In another aspect, the spindle comprises a head at the first end and the rod that extends axially outward from the head with the spindle comprising a one-piece unitary construction for the head and rod to rotate together as a unit.

In another aspect, the housing comprises a cylindrical shape with threads at the first end to engage with the threads of the spindle and the openings positioned at a second end.

In another aspect, a clip is configured to extend through the housing and the spindle and a connector operatively connects the clip to a head of the spindle.

In another aspect, the quick release pin comprises an angle plate and a connector that operatively connects the angle plate to the head of the spindle.

One aspect is directed to a quick release pin comprising a housing with a cylindrical shape. The housing comprises a hollow interior space, a threaded section, and an engagement section with openings that are in communication with the interior space. Ball members are positioned at the engagement section. A spring is positioned within the interior space. A spindle is positioned within the interior space of the housing. The spindle comprises threads that engage with the threaded section of the housing and a contact section that aligns with the engagement section of the housing. The spindle is rotatable relative to the housing between: a first rotational position that forces the ball members into the openings for the ball members to extend radially outward beyond an outer side of the housing; and a second rotational position that provides for the ball members to radially retract into the openings for the ball members to be positioned radially inward from the outer side of the housing.

In another aspect, the ball members have a spherical shape with a first diameter and the openings are evenly spaced around a perimeter of the housing and have a second diameter with the first diameter larger than the second diameter.

In another aspect, the spring is a torsion spring that is connected to the housing and to the spindle.

In another aspect, the contact section comprises paired extensions on opposing sides of a center point of the spindle and paired recesses between the paired extensions with the paired extensions comprising a greater width than the paired recesses.

In another aspect, the contact section is positioned at a distal end of the spindle and the threads are positioned at a proximal end of the spindle.

In another aspect, a clip is configured to extend through the housing and the spindle, a first connector operatively connects the clip to the spindle, and a second connector that operatively connects an angle plate to the spindle.

One aspect is directed to a method of securing a quick release pin to a member. The method comprises: positioning a spindle at a first rotational position within an interior space of housing with the first rotational position aligning recesses on the spindle with ball members at openings in a distal section of the housing; inserting the distal section of the housing through an opening in the member and forcing the ball members into the recesses and within an outer diameter of the housing; and after moving the distal section through the opening, positioning the spindle at a second rotational position within the interior space of the housing and radially forcing the ball members to protrude outward beyond the outer diameter of the housing.

In another aspect, the method further comprises attaching a clip to the distal section of the housing and the spindle after inserting the distal section of the housing through the opening.

In another aspect, the method further comprises transferring energy from the spindle to the housing through a torsion spring while rotating the spindle.

In another aspect, the method further comprises rotating a contact section of the spindle that contacts against the ball members and concurrently threading a distal end of the spindle onto a threaded section of the housing.

In another aspect, the method further comprises attaching an angle plate to the member and securing the spindle and housing to the member.

The features, functions and advantages that have been discussed can be achieved independently in various aspects or may be combined in yet other aspects, further details of which can be seen with reference to the following description and the drawings.

### BRIEF DESCRIPTION OF THE DRAWINGS

FIG. 1 is a side view of a quick release pin inserted through members.

FIG. 2 is a perspective view of a quick release pin.

FIG. 3 is an exploded view of the quick release pin of FIG. 2.

FIG. 4 is a schematic section view of a spindle positioned within an interior space of a housing.

FIG. 5 is a schematic end view of a contact section of a spindle.

FIG. 6A is a schematic end view of a spindle in a disengaged position.

FIG. 6B is a schematic end view of a spindle in an engaged position.

FIG. 7 is a flowchart diagram of a method of securing a quick release pin to a member.

FIG. 8 is a perspective view of a quick release pin.

### DETAILED DESCRIPTION

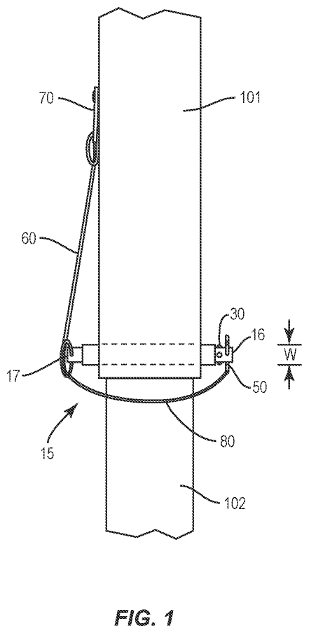

FIG. 1 illustrates a quick release pin 15 mounted to and locking together overlapping members 101, 102. The quick release pin 15 includes an elongated shape sized to extend through openings in the members 101, 102. A first end 16 is positioned on a first side of the members 101, 102 and a second end 17 is positioned on an opposing side. The quick release pin 15 is selectively movable between an engaged position and a disengaged position. In the engaged position, ball members 30 at the first end 16 are positioned radially outward to increase a width and prevent removal from the members 101, 102. In the disengaged position, the ball members 30 are retracted radially inward to reduce the width and allow for removal from the members 101, 102.

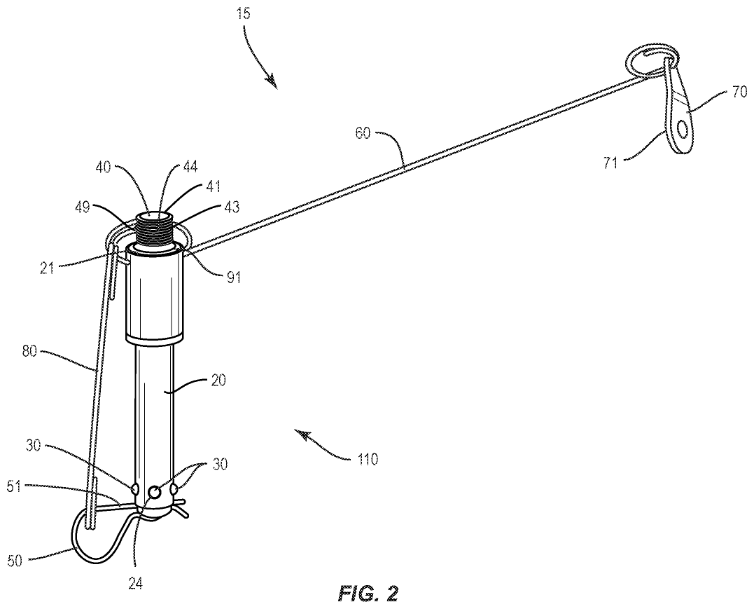

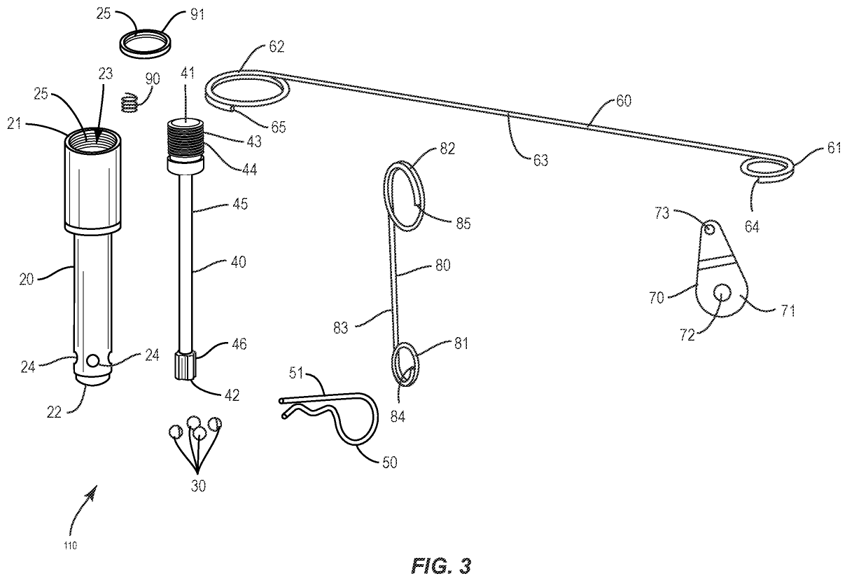

FIG. 2 illustrates the quick release pin 15 removed from the members 101, 102. FIG. 3 illustrates an exploded view of the quick release pin 15. The quick release pin 15 includes a housing 20 and a spindle 40. The spindle 40 is positioned within the housing 20 and selectively engages with ball members 30. The rotational position of the spindle 40 relative to the housing 20 controls the radial position of the ball members 30 between the engaged and disengaged positions.

In some examples, a clip 50 is configured to engage with the housing 20 and the spindle 40 to further secure the quick release pin 15 to the one or more members 101, 102. The clip 50 is attached to the spindle 40 through a connector 80. An angle plate 70 is used to further secure the quick release pin 15 to one or more of the members 101, 102. The angle plate 70 is secured to the spindle 40 through a connector 60.

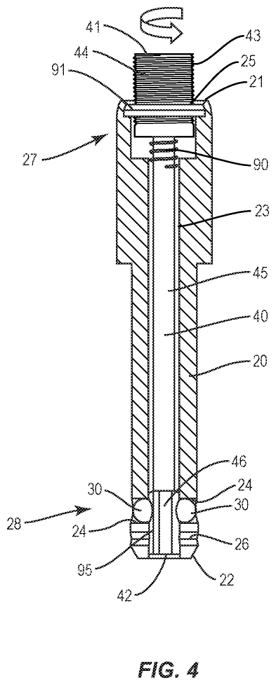

The housing 20 has a cylindrical shape with a first end 21 and an opposing second end 22. The housing 20 includes a hollowing interior space 23 as illustrated in FIG. 4. In some examples, the interior space 23 extends the entire length with each of the first and second ends 21, 22 being open. In other examples, the interior space 23 terminates away from the second end 22 with the second end 22 being closed. Threads 25 are positioned at the first end 21. In some examples, the threads 25 are formed on the inner surfaces of the housing 20 and face into the interior space 23. Additionally or alternatively, threads 25 are formed on a retainer 91 that is mounted to the housing 20 at the first end 21.

Openings 24 extend through the housing 20 and are in communication with the interior space 23. The openings 24 are positioned in proximity to the second end 22 and are configured to receive the ball members 30. The number and positioning of the openings 24 may vary. In one example, four openings 24 are spaced evenly apart around the housing 20 (i.e., centers of the openings 24 are spaced apart by 90). In another example, three openings 24 are evenly spaced apart around the housing 20 (i.e., the centers of the openings 24 are spaced apart by 120).

The spindle 40 is configured to be positioned within the interior space 23. The spindle 40 includes an elongated shape with a first end 41 and an opposing second end 42. A head 43 is positioned at the first end 41 and extends axially outward beyond the first end 21 of the housing 20 when the spindle 40 is inserted into the housing 20. The head 43 includes threads 44 that engage with the threads 25 on the housing 20 to provide for engagement and rotation of the spindle 40 with the housing 20.

The spindle 40 includes a rod 45 that axially extends outward from the head 43. The rod 45 includes a smaller width than the head 43. This smaller size provides for the rod 45 to fit within the interior space 23 of the housing 20. In one example as illustrated in FIG. 4, the interior space 23 includes a first section at the first end 21 that has a larger width to receive the head 43 and a second section that has a smaller width to receive the rod 45.

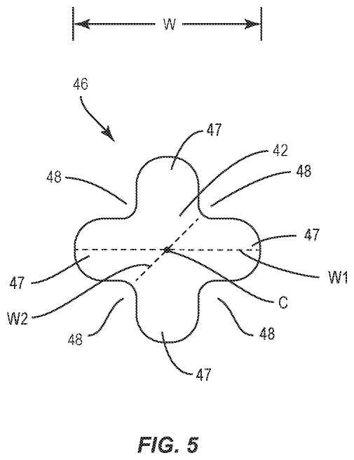

A contact section 46 is positioned along the rod 45. In one example, the contact section 46 is positioned at the second end 42 although other positioning is also possible. The contact section 46 is configured to engage with the ball members 30 to control the radial positioning within the openings 24. FIG. 5 illustrates an end view of the contact section 46 that includes extensions 47 and intermediate recesses 48. The extensions 47 are configured to contact against the ball members 30 in the engaged position and the recesses 48 are sized to receive the ball members 30 in the disengaged position. The extensions 47 extend outward a greater radial distance than the recesses 48 from a center point C of the spindle 40 (with the center point C positioned along a center line of the spindle 40). As illustrated in FIG. 5, the extensions 47 are aligned in pairs on opposing lateral sides of the spindle 40. In the example of FIG. 5, the extensions 47 include two paired extensions that each have a width W1 measured across the spindle 40 through the center point C. The recesses 48 are aligned in pairs that are on opposing lateral sides of the spindle 40 and include a smaller width W2. The number of extensions 47 and recesses 48 corresponds to the number of ball members 30. FIG. 5 includes a contact section 46 configured to be used with four ball members 30.

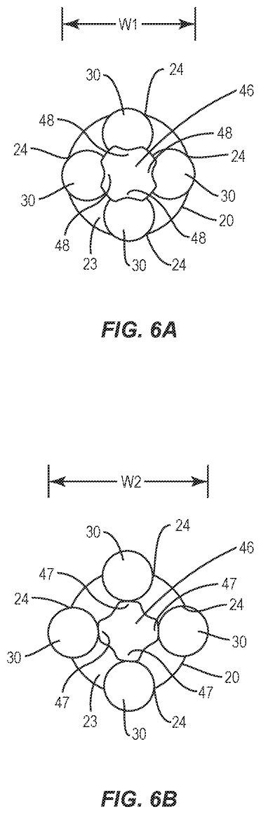

FIG. 6A illustrates the quick release pin 15 in a disengaged position with the spindle 40 at a first rotational position relative to the housing 20. The recesses 48 of the contact section 46 are aligned with the openings 24 in the housing 20. This rotational position provides for the ball members 30 to be positioned radially inward into the recesses 47 within interior space 23 of the housing 20. In some examples as illustrated in FIG. 6A, a limited portion of the ball members 30 extend outward from the openings 24 when the ball members 30 are seated in the recesses 48. In other examples, the ball members 30 are completed recessed within the openings 24. In the disengaged position, the quick release pin 15 has a first width W1.

FIG. 6B illustrates the quick release pin 15 in the engaged position with the spindle 40 at a different second rotational position relative to the housing 20. The extensions 47 are aligned with the openings 24. This positions the ball members 30 radially outward through the openings 24. This extended positioning provides for the width W2 of the quick release pin 15 to be greater.

In some examples, the openings in the one or more members 101, 102 includes a width that is greater than the width W1 to allow for insertion and removal of the quick release pin 15 when in the disengaged position. Further, the width of the one or more openings is smaller than the width W2 in the engaged position to prevent the quick release pin 15 from being removed from the members 101, 102.

The ball members 30 include a spherical shape that is sized to move within the interior space 23 formed between the housing 20 and contact section 46 of the spindle 40. A diameter of the ball members 30 is larger than the diameter of the openings 24. This sizing provides for the ball members 30 to remain engaged with the housing 20 and prevent escape through the openings 24. In some examples, each of the ball members 30 includes the same shape and size. Other examples include different sizes for two or more of the ball members 30.

A torsion spring 90 is positioned within the interior space 23. The torsion spring 90 includes a coil that wraps around the rod section 45 of the spindle. The torsion spring 90 includes an axis that extends through the coil and is aligned along the centerline of the spindle 40. The torsion spring 90 includes a first end that is attached to the spindle 40 and a second end that is attached to the housing 20. During rotation of the spindle 40, the torsion spring 90 applies a force to the spindle 40 and housing 20.

A retainer 91 is secured to the housing 20 at the first end 21. In some examples, the retainer 91 includes threads that engage with the threads 44 on the head 43 of the spindle 40.

FIG. 4 illustrates the quick release pin 15 in the disengaged position. The spindle 40 is at a first rotational position that aligns the recesses 48 with the openings 24. The ball members 30 move into the housing 20 thus reducing the width of the quick release pin 15.

As illustrated in FIG. 4, the housing 20 includes openings 26 that extend through opposing sides and are aligned along a straight line. The openings 26 are positioned between the openings 24 and the second end 22. An opening 95 extends through the spindle 40 at the second end 22. The opening 95 is configured to be aligned with the openings 26 in the housing 20 to receive the clip 50. The clip 50 includes a straight section 51 configured to be inserted through the openings 26, 95 to further secure the quick release pin 15.

The angle plate 70 includes a flat body 71 with a pair of openings 72, 73. Opening 72 is sized to receive a fastener to secure to one of the members 101, 102 or other structural support. Opening 73 is configured to be attached to the connector 60.

Connector 60 connects the plate 70 to the head 43 of the spindle 40. Connector 80 connects the clip 50 to the head 43 of the spindle 40. In one example, each of the connectors 60, 80 is constructed from a deformable material, such as a wire. The connectors 60, 80 include loops 61, 62, 81, 82 respectively at the outer ends. The loops 61, 62, 81, 82 include overlapping coils with exposed ends 64, 65, 84, 85 that provide for attachment to the respective plate 70 and clip 50. In some examples, loop 62 is inserted through an opening 49 that extends through the head 43 of the spindle 40. Loop 82 is attached to loop 62. In other examples, loop 82 is connected to the head 43 and loop 62 is attached to loop 82. The attachment of the connectors 60, 80 to the spindle 40 through the loops 62, 82 allows for the spindle 40 to be rotated during use.

In one example during use, the clip 50 is removed and the spindle 40 is rotated to the disengaged position. The distal end of the quick release pin 15 is then inserted into openings in the one or more members 101, 102. The width of the distal section is smaller than the openings to provide for the insertion. In some examples during insertion, the ball members 30 move radially inward into the interior space 23 and against the recesses 48 due to the contact with the one or more members 101, 102.

Once inserted, the spindle 40 is rotated relative to the housing 20. This rotation aligns the extensions 47 on the spindle 40 with the openings 24 in the housing 20. This rotation also contacts the extensions 47 against the ball members 30 and radially moves the ball members 30 outward from the openings 24. This position increases the width of the distal section to be greater than the size of the openings in the one or more members 101, 102 and prevents removal while in the engaged position.

Removal of the quick release pin 15 includes rotating the spindle 40 to the disengaged position. Once at this rotational position, the quick release pin 15 is pulled through the openings in the one or more members 101, 102. The ball members 30 contact against the one or more members 101, 102 and radially retract to allow for the distal section to be removed.

In some examples the clip 50 is inserted to the distal section after insertion into the one or more members 101, 102. The clip 50 further prevents removal of the quick release pin 15. Additionally or alternatively, the angle plate 70 is attached to the one or more members 101, 102 or some other component. This attachment can occur prior to or after insertion of the distal section. The angle plate 70 provides for attaching the quick release pin 15 to prevent it from dropping or otherwise being lost when it is not inserted.

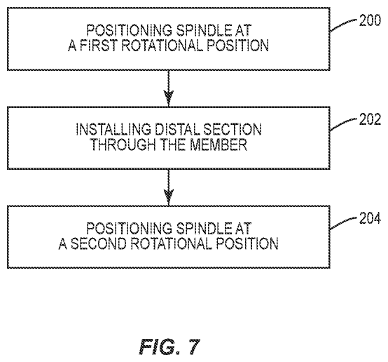

FIG. 7 illustrates a method of securing a quick release pin 15 to a member 101. The spindle 40 is positioned at a first rotational position within an interior space 23 of the housing 20 (block 200). The first rotational position aligns recesses 48 on the spindle 40 with ball members 30 at openings 24 in the distal section of the housing 20. The distal section is inserted through an opening in the member (block 202). The insertion applies forces to the ball members 30 that move the ball members 30 into the recesses 48 and within an outer diameter of the housing 20. After moving the distal section through the opening, the spindle 40 is positioned at a second rotational position (block 204). This second rotational position forces the ball members 30 to protrude outward beyond the outer diameter of the housing 20.

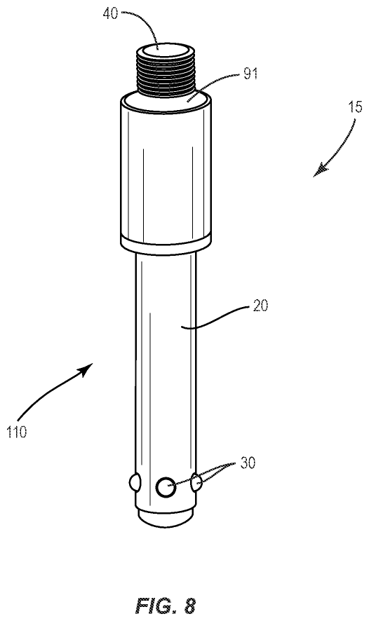

In one example, the quick release pin 15 includes the connectors 60, 80, angle plate 70, and the clip 50. In another example as illustrated in FIG. 8, the quick release pin 15 does not include these additional elements. The quick release pin 15 includes the housing 20, spindle 40, ball members 30, and the spring 90. The quick release pin 15 may or may not include the retainer 91.

In some examples, the quick release pin 15 does not include the spring 90.

FIG. 1 illustrates the quick release pin 15 inserted through openings in a pair of members 101, 102. The quick release pin 15 can be used to lock together different numbers of members. In one example, the quick release pin 15 is engaged with a single member. In another example, the quick release pin 15 is inserted through three or more overlapping members.

The present quick release pin may be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A quick release pin comprising:
a housing comprising:
a hollow interior space;
openings that extend through the housing;
ball members positioned at the openings;
a spindle comprising a contact section that aligns with the openings in the housing, the contact section comprising extensions and recesses;
a spring attached to the housing and the spindle; and
wherein the spindle is rotatable within the housing to selectively force the ball members radially outward through the openings and allow for the ball members to radially retract in the openings.

2. The quick release pin of claim 1, wherein the ball members comprise a first diameter and the openings comprise a second diameter, wherein the first diameter is larger than the second diameter to prevent the ball members from escaping from the housing through the openings.

3. The quick release pin of claim 1, wherein the contact section is positioned at a distal end of the spindle.

4. The quick release pin of claim 1, wherein the spring is a torsion spring that applies a force to the housing upon rotation of the spindle.

5. The quick release pin of claim 1, wherein the contact section comprises a cross-sectional width that is measured through a center point of the spindle, the cross-sectional width being greater at the extensions than at the recesses.

6. The quick release pin of claim 1, wherein the spindle comprises a head at the first end and the rod that extends axially outward from the head, the spindle comprising a one-piece unitary construction for the head and rod to rotate together as a unit.

7. The quick release pin of claim 1, wherein the housing comprises a cylindrical shape with threads at the first end to engage with the threads of the spindle and the openings positioned at a second end.

8. The quick release pin of claim 1, further comprising:
a clip configured to extend through the housing and the spindle; and
a connector that operatively connects the clip to a head of the spindle.

9. The quick release pin of claim 8, further comprising:
an angle plate; and
a connector that operatively connects the angle plate to the head of the spindle.

10. A quick release pin comprising:
a housing with a cylindrical shape, the housing comprising:
an interior space that is hollow;
a threaded section;
an engagement section with openings that are in communication with the interior space;
ball members positioned at the engagement section;
a spring positioned within the interior space;
a spindle positioned within the interior space of the housing, the spindle comprising:
threads that engage with the threaded section of the housing;
a contact section that aligns with the engagement section of the housing; and
wherein the spindle is rotatable relative to the housing between:
a first rotational position that forces the ball members into the openings for the ball members to extend radially outward beyond an outer side of the housing; and
a second rotational position that provides for the ball members to radially retract into the openings for the ball members to be positioned radially inward from the outer side of the housing.

11. The quick release pin of claim 10, wherein:
the ball members have a spherical shape with a first diameter;
the openings are evenly spaced around a perimeter of the housing and have a second diameter;
the first diameter is larger than the second diameter.

12. The quick release pin of claim 10, wherein the spring is a torsion spring that is connected to the housing and to the spindle.

13. The quick release pin of claim 10, wherein the contact section comprises paired extensions on opposing sides of a center point of the spindle and paired recesses between the paired extensions, the paired extensions comprising a greater width than the paired recesses.

14. The quick release pin of claim 10, wherein the contact section is positioned at a distal end of the spindle and the threads are positioned at a proximal end of the spindle.

15. The quick release pin of claim 10, further comprising:
a clip configured to extend through the housing and the spindle;
a first connector that operatively connects the clip to the spindle;
an angle plate; and
a second connector that operatively connects the angle plate to the spindle.

16. A method of securing a quick release pin to a member, the method comprising:
positioning a spindle at a first rotational position within an interior space of cylindrical housing, the first rotational position aligning recesses on the spindle with ball members at openings in a distal section of the housing;
inserting the distal section of the housing through an opening in the member and forcing the ball members into the recesses and within an outer diameter of the housing; and
after moving the distal section through the opening, positioning the spindle at a second rotational position within the interior space of the housing and radially forcing the ball members to protrude outward beyond the outer diameter of the housing.

17. The method of claim 16, further comprising attaching a clip to the distal section of the housing and the spindle after inserting the distal section of the housing through the opening.

18. The method of claim 16, further comprising transferring energy from the spindle to the housing through a torsion spring while rotating the spindle.

19. The method of claim 16, further comprising rotating a contact section of the spindle that contacts against the ball members and concurrently threading a distal end of the spindle onto a threaded section of the housing.

20. The method of claim 16, further comprising attaching an angle plate to the member and securing the spindle and housing to the member.
